(19) United States
(12) Patent Application Publication
(10) Pub. No.: US 2015/0039915 A1
(43) Pub. Date: Feb. 5, 2015

(54) SERVER POWER SYSTEM

(71) Applicants: HONG FU JIN PRECISION INDUSTRY (ShenZhen) CO., LTD, Shenzhen (CN); HON HAI PRECISION INDUSTRY CO., LTD., New Taipei (TW)

(72) Inventors: LEI DENG, Shenzhen (CN); FEI TENG, Shenzhen (CN); KANG WU, Shenzhen (CN)

(21) Appl. No.: 14/451,447

(22) Filed: Aug. 5, 2014

(30) Foreign Application Priority Data
Aug. 5, 2013 (CN) 2013103349734

(51) Int. Cl. G06F 1/26

(52) U.S. Cl. CPC G06F 1/26
USPC 713/300

(57) ABSTRACT

A server power system includes a backboard with a plurality of hard disk drive (HDD) units, a number of motherboards, and a number of power cables. The numbers of the HDD units, the motherboards, and the power cables are the same. Each HDD unit includes a number of HDDs. Each HDD of one HDD unit is coupled to a corresponding motherboard through a corresponding power cable. Each power cable includes a motherboard interface and an HDD interface. A ground pin and a power pin of the HDD interface are connected to a ground pin and a power pin of the motherboard interface correspondingly. The motherboard interface of each power cable is coupled to a power interface of the corresponding motherboard. The number of the power cables is selected to make the HDDs of each HDD unit coupled to the HDD interfaces of the corresponding power cables.

### FIELD

The present disclosure relates to a power system for a server.

### BACKGROUND

Multiple of hard disk drives (HDDs) are applied in a server. The HDDs are usually disposed on an HDD backboard, to be coupled to a corresponding motherboard in the server through a corresponding power cable.

### BRIEF DESCRIPTION OF THE DRAWINGS

Implementations of the present technology will now be described, by way of example only, with reference to the attached figures, wherein:

FIG. 1 is a diagrammatic illustration of an embodiment of a backboard of a power system for a server.

FIG. 2 is a diagrammatic illustration of an embodiment of a power cable of the power system for a server.

FIG. 3 is a diagrammatic illustration of a first embodiment of HDD units of the server power system.

FIG. 4 is a diagrammatic illustration of a second embodiment of HDD units of the server power system.

FIG. 5 is a diagrammatic illustration of a third embodiment of HDD units of the server power system.

### DETAILED DESCRIPTION

Numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawing is not necessarily to scale to better illustrate details and features of the present disclosure.

Several definitions that apply throughout this disclosure will now be presented.

The term “coupled” is defined as coupled, whether directly or indirectly through intervening components, and is not necessarily limited to physical connections. The connection can be such that the objects are permanently coupled or releasably coupled. The term “comprising,” when utilized, means “including, but not necessarily limited to”; it specifically indicates open-ended inclusion or membership in the so-described combination, group, series and the like.

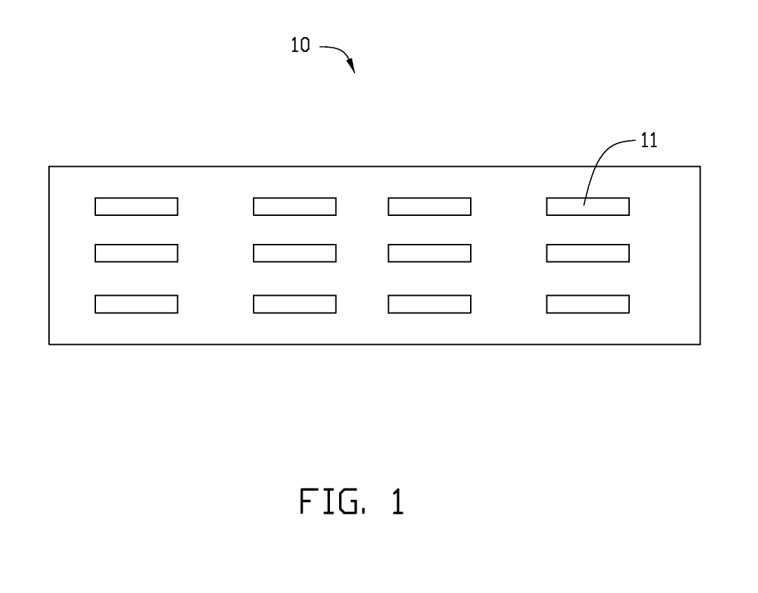

FIG. 1 illustrates a diagrammatic illustration of one embodiment of a backboard 10. The backboard 10 includes twelve hard disk drives (HDDs) 11, according to an array of three HDDs arranged in horizontal, and four HDDs arranged in longitudinal.

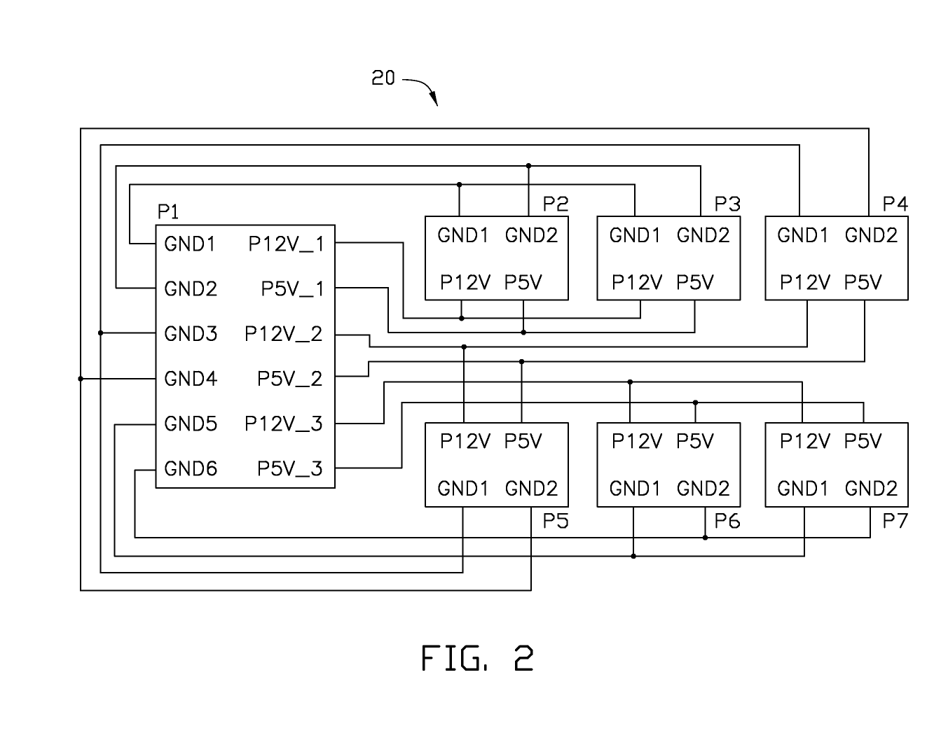

FIG. 2 illustrates a diagrammatic illustration of one embodiment of a power cable 20 of a server power system 100. The power cable 20 includes a motherboard interface P1 and six HDD interfaces P2, P3, P4, P5, P6, and P7. The motherboard interface P1 includes six power pins P12V_1, P5V_1, P12V2, P5V_2, P12V_3, and P5V_3, and six ground pins GND1, GND2, GND3, GND4, GND5, and GND 6. Each of the HDD interfaces P2, P3, P4, P5, P6, and P7 includes two power pins P12V, P5V and two ground pins GND1, GND2. In one embodiment, the two power pins P12V, P5V of the HDD interface P2 are coupled to the power pins P12V_1, P5V_1 of the motherboard interface P1, respectively. The ground pins of GND 1, GND2 of the HDD interfaces P2 are coupled to the ground pins GND1, GND2 of the motherboard interface P1, respectively. The power pins P12V, P5V of the HDD interface P3 are coupled to the power pins P12V_1, P5V_1 of the motherboard interface P1, respectively. The ground pins GND1, GND2 of the HDD interface P3 are coupled to the ground pins GND1, GND2 of the motherboard interface P1, respectively. The power pins P12V, P5V of the HDD interface P4 are coupled to the power pins P12V2, P5V_2 of the motherboard interface P1, respectively. The ground pins GND1, GND2 of the HDD interface P4 are coupled to the ground pins GND3, GND4 of the motherboard interface P1, respectively. The power pins P12V, P5V of the HDD interface P5 are coupled to the power pins P12V2, P5V_2 of the motherboard interface P1, respectively. The ground pins GND1, GND2 of the HDD interface P5 are coupled to the ground pins GND3, GND4 of the motherboard interface P1, respectively. The power pins P12V, P5V of the HDD interface P6 are coupled to the power pins P12V_3, P5V_3 of the motherboard interface P1, respectively. The ground pins GND1, GND2 of the HDD interface P6 are coupled to the ground pins GND5, GND6 of the motherboard interface P1, respectively. The power pins P12V, P5V of the HDD interface P7 are coupled to the power pins P12V_3, P5V_3 of the motherboard interface P1, respectively. The ground pins GND1, GND2 of the HDD interface P7 are coupled to the ground pins GND5, GND6 of the motherboard interface P1, respectively.

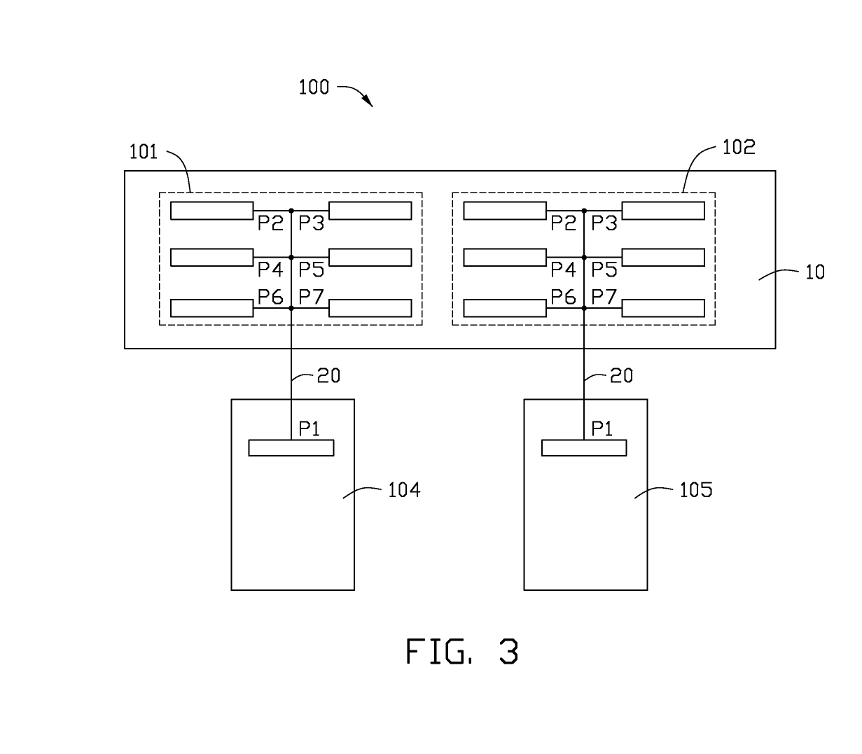

FIG. 3 illustrates a diagrammatic illustration of a first embodiment of the server power system 100 with two HDD units 101, 102 divided on the backboard 10. The server power system 100 includes two power cables 20 and two motherboards 104,105 coupled to the two HDD units 101, 102 through the two power cables 20, respectively. Power ports of the motherboards 104, 105 are coupled to the corresponding motherboard interfaces P1 of the two power cables 20. Thus, the six ground pins GND1, GND2, GND3, GND4, GND5, and GND 6 of each power cable 20 are coupled to ground pins of each of the motherboards 104, 105, respectively. The three power pins P12V_1, P12V_2, P12V_3 of the motherboard interface P1 of each power cable 20 are coupled to power pins 12V of each of the motherboards 104, 105, respectively. The three power pins P5V_1, P5V_2, P5V_3 of the motherboard interface P1 of each power cables 20 are coupled to power pins 5V of each of the motherboards 104, 105, respectively. Power ports of the six HDDs of each of the HDD units 101, 102 are coupled to the six HDD interfaces P2, P3, P4, P5, P6, and P7 of each power cable 20, respectively. Therefore, the motherboards 104, 105 can supply power to the HDD units 101, 102 through the power cables 20, respectively.

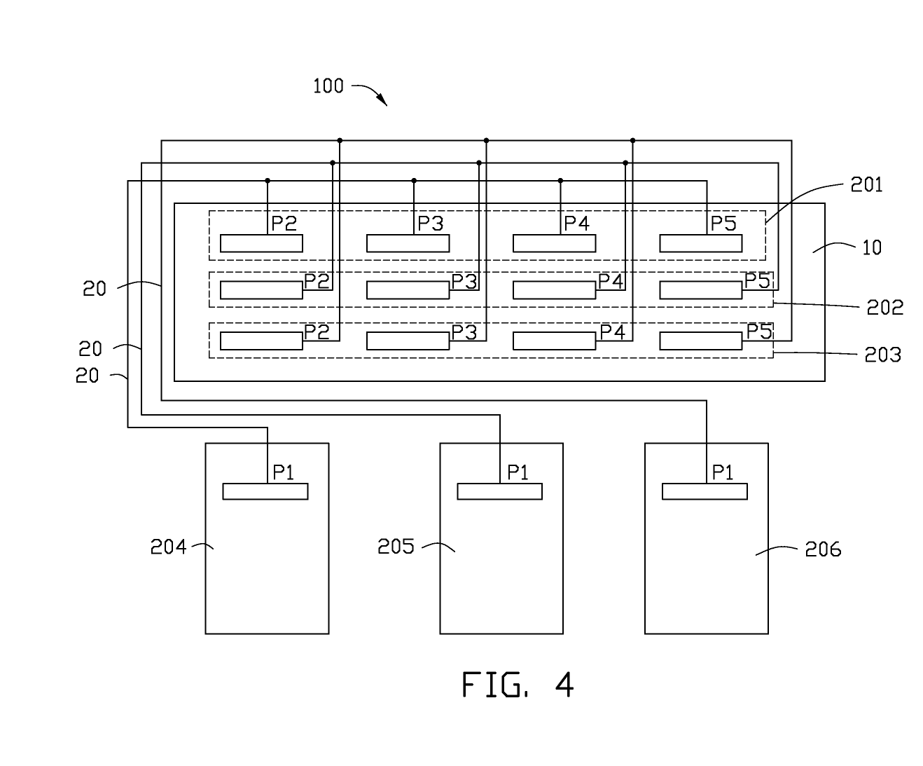

FIG. 4 illustrates a diagrammatic illustration of a second embodiment of the server power system 100 with three HDD units 201, 202, 203 divided on the backboard 10. The server power system 100 includes three power cables 20 and three motherboards 204, 205, 206 coupled to the third HDD units 201, 202, 203 through the three power cables 20, respectively. Power ports of the motherboards 104, 105 are coupled to the corresponding motherboard interfaces P1 of the three power cables 20. Thus, the six ground pins GND1, GND2, GND3, GND4, GND5, and GND 6 of each power cable 20 are coupled to ground pins of each of the motherboards 204, 205, 206, respectively. The three power pins P12V_1, P12V2, P12V_3 of the motherboard interface P1 of each power cable 20 are coupled to power pins 12V of each of the motherboards 204, 205, 206, respectively. The three power pins P5V_1, P5V_2, P5V_3 of the motherboard interface P1 of each power cable 20 are coupled to power pins 5V of each of the motherboards 204, 205, 206, respectively. Power ports of the six HDDs of each of the HDD units 201, 202, 203 are coupled to the six HDD interfaces P2, P3, P4, P5, P6, and P7 of each power cable 20, respectively. Therefore, the motherboards 204, 205, 206 can supply power to the HDD units 201, 202, 203 through the power cables 207, 208, 209, respectively.

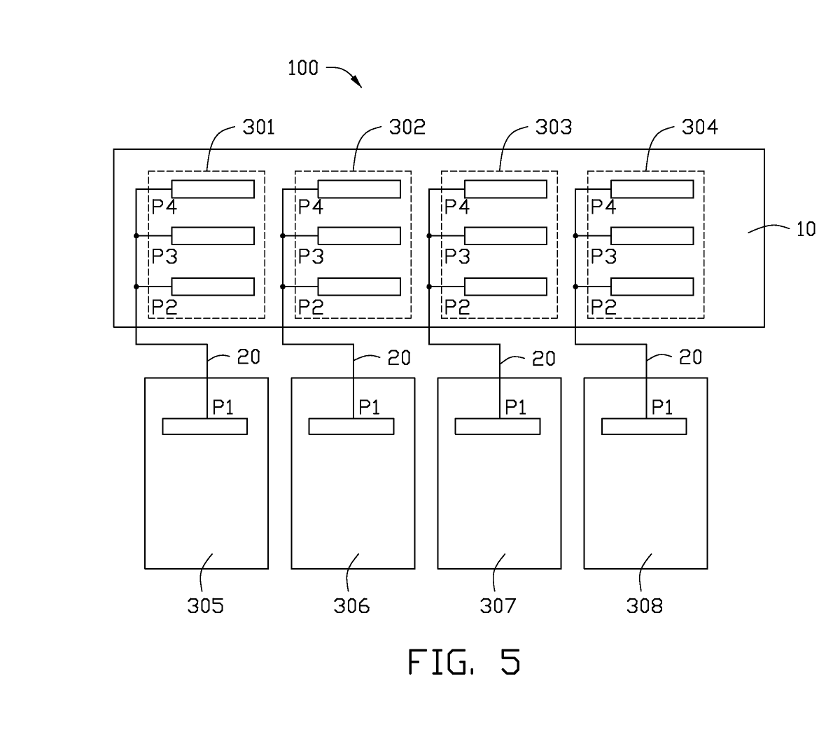

FIG. 5 illustrates a diagrammatic illustration of a third embodiment of the server power system 100 with four HDD units 301, 302, 303, 304 divided on the backboard 10. The server power system 100 includes four power cables 20 and four motherboards 305, 306, 307, 308 coupled to the two HDD units 301, 302, 303, 304 through four power cables 20, respectively. Power ports of the motherboards 305, 306, 307, 308 are coupled to the corresponding motherboard interfaces P1 of the four power cables 20. Thus, the six ground pins GND1, GND2, GND3, GND4, GND5, and GND 6 of each power cable 20 are coupled to ground pins of each of the motherboards 305, 306, 307, 308, respectively. The three power pins P12V_1, P12V_2, P12V_3 of the motherboard interface P1 of each power cable 20 are coupled to power pins 12V of each of the motherboards 305, 306, 307, 308, respectively. The three power pins P5V_1, P5V_2, P5V_3 of the motherboard interface P1 of each power cable 20 are coupled to power pins 5V of each of the motherboards 305, 306, 307, 308, respectively. Power ports of the six HDDs of each of the HDD units 301, 302, 303, 304 are coupled to the six HDD interfaces P2, P3, P4, P5, P6, and P7 of each power cable 20, respectively. In the embodiment, selecting three HDD interfaces P2, P3, P4 of the six HDD interfaces of each of the power cables 20 to be coupled to the corresponding power ports of the four HDDs of each of the HDD units 301, 302, 303, 304. Of course, any three HDD interfaces of the six HDD interfaces P2, P3, P4, P5, P6, P7 can be selected to be coupled to the power ports of the three HDDs of the corresponding HDD unit. Therefore, the motherboards 305, 306, 307, 308 can supply power to the HDD units 301, 302, 303, 304 through the four power cables 20, respectively.

The embodiments shown and described above are only examples. Many details are often found in the art such as the other features of server power system a server power system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A server power system comprising:
a backboard comprising a plurality of hard disk drive (HDD) units, each of the HDD units comprising a plurality of HDDs;
a plurality of motherboards, each of the plurality of motherboards coupled to a corresponding one of the plurality of HDD units so that a total number of the plurality of motherboards is equal to a total number of the plurality of HDD units; and
a plurality of power cables with same numbers as those of the motherboards, wherein each of the power cables comprises a motherboard interface and a plurality of HDD interfaces, a ground pin of each HDD interface is coupled to a corresponding ground pin of the motherboard interface, a 12 voltage (V) power pin of each HDD interface is coupled to a corresponding 12V power pin of the motherboard interface;
a 5 V power pin of each HDD interface is coupled to a corresponding 5V power pin of the motherboard interface; and
wherein the motherboard interface of each of the power cables is coupled to a power port of a corresponding motherboard, wherein a plurality of the HDD interfaces of each power cable with the same numbers of those of the HDDs of an HDD unit is selected to make each HDD interface coupled to a corresponding HDD.

2. The server power system of claim 1, wherein the backboard comprises twelve HDDs.

3. The server power system of claim 2, wherein the HDD interfaces of each of the power cables comprise a first HDD interface, a second HDD interface, a third HDD interface, a fourth HDD interface, a fifth HDD interface, and a sixth HDD interface; each motherboard interface of each power cable comprises a first ground pin, a second ground pin, a third ground pin, a fourth ground pin, a fifth ground pin, a sixth ground pin, a first 12V power pin, a second 12V power pin, a third 12V power pin, a first 5V power pin, a second 5V power pin, and a third 5V power pin; each of the HDD interfaces comprises a first ground pin, a second ground pin, a 12V power pin, and a 5V power pin; the first ground pin of each the motherboard interface is coupled to the first ground pins of the first and second HDD interfaces; the second ground pin of each the motherboard interface is coupled to the second ground pins of the first and second HDD interfaces; the third ground pin of each the motherboard interface is coupled to the first ground pins of the third and fourth HDD interfaces; the fourth ground pin of each the motherboard interface is coupled to the second ground pins of the third and fourth HDD interfaces; the fifth ground pin of each the motherboard interface is coupled to the first ground pins of the fifth and sixth HDD interfaces; the sixth ground pin of each the motherboard interface is coupled to the second ground pins of the fifth and sixth HDD interfaces;
the first 12V power pin of each motherboard interface is coupled to the 12V power pin of the first and second HDD interfaces; the first 5V power pin of each motherboard interface is coupled to the 5V power pin of the first and second HDD interfaces; the second 12V power pin of each motherboard interface is coupled to the 12V power pin of the third and fourth HDD interfaces; the second 5V power pin of each motherboard interface is coupled to the 5V power pin of the third and fourth HDD interfaces; the third 12V power pin of each motherboard interface is coupled to the 12V power pin of the fifth and sixth HDD interfaces; and the third 5V power pin of each motherboard interface is coupled to the 5V power pin of the fifth and sixth HDD interfaces.

4. The server power system of claim 3, wherein the backboard comprises two HDD units, each of the HDD units comprises six HDDs, the number of the motherboards and the number of the power cables each are two, the six HDDs of each HDD unit are coupled to the six HDD interfaces of each power cable, respectively, the motherboard interface of each power cable is coupled to the corresponding motherboard.

5. The server power system of claim 3, wherein each backboard comprises three HDD units, each HDD unit comprises four HDDs, the number of the motherboards and the power cables is three, the four HDDs of each HDD unit are coupled to the four HDD interfaces of each power cable, respectively, the motherboard interface of each power cable is coupled to the corresponding motherboard.

6. The server power system of claim 3, wherein each backboard comprises four HDD units, each HDD unit comprises three HDDs, the number of the motherboards and the power cables is four, the three HDDs of each HDD unit are coupled to the three HDD interfaces of each power cable, respectively, the motherboard interface of each power cable is coupled to the corresponding motherboard.
